(19) United States
(12) Patent Application Publication
(10) Pub. No.: US 2002/0111707 A1
(43) Pub. Date: Aug. 15, 2002

(54) Droplet deposition method for rapid formation of 3-D objects from non-cross-linking reactive polymers

(76) Inventors: Zhimin Li, Auburn, AL (US); Tan Zhang, Auburn, AL (US); Lulu Song, Auburn, AL (US); Bor Zeng Jang, Auburn, AL (US)

Correspondence Address: Bor Z. Jang, 2076 S. Evergreen Dr., Auburn, AL, 36830, US

(21) Appl. No.: 09/742,479

(22) Filed: Dec. 20, 2000

(51) Int. Cl. G06F 19/00

(52) U.S. Cl. 700/118

(57) ABSTRACT

A droplet deposition-based freeform fabrication method for making a three-dimensional object from a design created on a computer, including (a) providing a support member; (b) operating a droplet dispensing head for dispensing droplets of a material composition in a fluent state at a first temperature onto the support member, the material composition including a reactive prepolymer with a melting point above 23° C. and the first temperature being greater than the prepolymer melting point; (c) operating material treatment devices for causing the material composition to rapidly achieve a rigid state in which the material composition is substantially solidified to build up the 3-D object, the material treatment devices also working to convert the reactive prepolymer to a higher molecular weight thermoplastic resin; and (d) operating control devices for generating control signals in response to coordinates of the object design to control the movement of the dispensing head relative to the support member and for controlling the droplet dispensing of the material composition to construct the 3-D object.

### FIELD OF THE INVENTION

This invention relates generally to a layer manufacturing method that involves droplet ejection and deposition of a special class of material compositions for the formation of a three-dimensional (3-D) object in an essentially point-by-point and layer-by-layer manner. Specifically, this material composition contains a reactive pre-polymer which helps to make the material composition in a fluent state before droplet ejection and is capable of rapidly solidifying by chain extension after droplet ejection to facilitate freeform fabrication of a 3-D object under the control of a computer.

### BACKGROUND OF THE INVENTION

The last decade has witnessed the emergence of a new frontier in the manufacturing technology, commonly referred to as solid free form fabrication (SFF) or layer manufacturing (LM). A LM process typically involves representing a 3-D object with a computer-aided design (CAD) geometry file. The file is then converted to a machine control command and tool path file that serves to drive and control a part-building tool (e.g., an extrusion head) for building parts essentially point-by-point or layer-by-layer. The LM processes were developed primarily for making concept models, molds and dies, and prototype parts. They are capable of producing a freeform solid object directly from a CAD model without part-specific tooling or human intervention. A SFF process also has potential as a cost-effective production process if the number of parts needed at a given time is relatively small. Use of SFF could reduce tool-making time and cost, and provide the opportunity to modify tool design without incurring high costs and lengthy time delays. A SFF process can be used to fabricate certain parts with a complex geometry which otherwise could not be practically made by traditional fabrication approaches such as machining.

Examples of more commonly used SFF techniques include stereo lithography (SLa), selective laser sintering (SLS), 3-D printing (3-DP), inkjet printing, laminated object manufacturing (LOM), fused deposition modeling (FDM), laser-assisted welding or cladding, and shape deposition modeling (SDM). In most of these techniques, the fabrication of a 3-D object either requires the utilization of expensive and difficult-to-handle materials or depends upon the operation of heavy, complex and expensive processing equipment. For instance, the photo-curable epoxy resin used in the stereo lithography process can cost up to US$200 per pound. Melting of metallic, ceramic, and glass materials involves a high temperature and could require expensive heating means such as an induction generator or a laser. Fully polymerized thermoplastics also require a moderately high temperature (normally in the range of 150° C. to 400° C.) to reach a low-viscosity state for processing. Other shortcomings of the prior-art SFF techniques are briefly summarized as follows:

The FDM process (e.g., U.S. Pat. No. 5,121,329; 1992 to S. S. Crump) operates by employing a heated nozzle to melt and extrude out a material such as nylon, ABS plastic (acrylonitrile-butadiene-styrene) and wax. The build material is supplied into the nozzle in the form of a rod or filament. The filament or rod is introduced into a channel of a nozzle inside which the rod/filament is driven by a motor and associated rollers to move like a piston. The front end, near a nozzle tip, of this piston is heated to become melted; the rear end or solid portion of this piston pushes the melted portion forward to exit through the nozzle tip. The nozzle is translated under the control of a computer system in accordance with previously sliced CAD data to trace out a 3-D object point by point and layer by layer. This process has a drawback that it requires a separate apparatus to pre-shape a build material into a precisely dimensioned rod or filament form. The re-melting of this rod or filament in a FDM nozzle requires additional heating elements placed around or inside the body of the nozzle. The nozzle has to be heated to at least 240° C. and 280° C. to thoroughly melt out ABS and nylon, respectively.

A particularly useful SFF technique is based on extrusion of heat-meltable materials or thermoplastics. In principle, a bulk quantity of materials (thermoplastics and wax) can be melted and directly transferred to a dispensing nozzle for deposition; it does not require the preparation of a raw material to a special shape followed by re-melting. Extrusion-based SFF processes can be found in U.S. Pat. No. 5,141,680 (Aug. 25, 1992) to Almquist and Smalley, U.S. Pat. No. 5,303,141 (Apr. 12, 1994) and U.S. Pat. No. 5,402,351 (Mar. 28, 1995) both to Batchelder, et al., and U.S. Pat. No. 5,656,230 (Aug. 12, 1997) to Khoshevis. In these examples, the starting material is heated to become a melt and then transferred to a dispensing head by using a gear pump, a positive-displacement valve, an air-operated valve, or an extruder. The nozzle also must be heated to maintain the material in the molten state prior to being extruded out for deposition. Wax materials, although processable at a temperature lower than 120° C., are too weak and brittle. Again, the processing of fully polymerized thermoplastics require relatively high melting temperatures.

Examples of extrusion-based SFF techniques using thermosetting resins are given in U.S. Pat. No. 5,134,569 (Jul. 28, 1992) to Masters and U.S. Pat. No. 5,204,124 (Apr. 20, 1993) to Secretan and Bayless. Both systems require the use of an ultra-violet (UV) beam or other high energy sources to rapidly cure a thermosetting resin which undergoes a cross-linking reaction for forming a three-dimensional, covalent-bonded network. Photo-curable or fast heat-curable resins are known to be expensive and the curing processes have very limited processing windows; curing of these materials has been inconsistent and difficult and the results have not been very repeatable. In general, the resulting materials, being highly cross-linked, are very brittle.

In U.S. Pat. No. 4,665,492, issued May 12, 1987, Masters teaches a technique of part fabrication by spraying liquid resin drops, a process commonly referred to as Ballistic Particle Modeling (BPM). The BPM process includes heating a supply of thermoplastic resin to above its melting point and pumping the liquid resin to a nozzle, which ejects small liquid droplets from different directions to deposit on a substrate. Commercial BPM machines are capable ofjetting only thermoplastics with a low melting point or glass transition temperature (Tg) such as wax and high-impact polystyrene (HIPS). BPM process is also further proposed in (1) W. E. Masters, U.S. Pat. No. 5,216,616, June 1993; (2) H. E. Menhennett and R. B. Brown, U.S. Pat. No. 5,555,176, September 1996; and (3) D. W. Gore, U.S. Pat. No. 5,257,657, November 1993.

In U.S. Pat. No. 5,136,515, August 1992, Helinski proposed a RP process for producing a 3-D object layer by layer by jetting droplets of two different hardenable materials into the various layers with one material forming the object itself and the other forming a support for the object as necessary. In two follow-up patents (U.S. Pat. No. 5,506,607, April 1996 and U.S. Pat. No. 5,740,051, April 1998), Sanders, et al. provided a more detailed description of this inkjet-based process. These three patents led to the development of commercial inkjet printing systems (e.g., Model Maker-II by Sanders Prototypes, Inc.). These systems make use of wax and low-melting thermoplastic materials. The process proposed by Yamane, et al. (U.S. Pat. No. 5,059,266, October 1991 and U.S. Pat. No. 5,140,937, August 1992.) involves jetting droplets of a thermosetting material from print-heads to a stage, which is used to mount a 3-D object being built. The print-head unit is positioned below the stage. The jetting direction and jetting amount of the material can be changed according to the geometry information of the object. This process is similar to BPM in that two or more print-heads can be used to deposit materials from different orientations. A difference is that the print-heads in the Yamane process are generally orientated upside-down so that the droplets are ejected generally upward. Due to no support structure, it is difficult for this upside-down inkjet process to build any object with features such as an overhang, an isolated island or any other non-self-supporting corner.

Jetting of most fully polymerized thermoplastic resins would require heating the material to a molten state at a temperature much higher than 125° C., which is the maximum working temperature of a lead-zirconate-titanate (PZT) based piezo-electric actuator element. PZT is the most commonly used piezo-electric material in inkjet printing applications; e.g., 2-D color printing. It would be very advantageous to use this well-developed technique for “printing” a 3-D object point by point and layer by layer. Very few thermoplastic resins with either a melting point (Tm for a crystalline polymer) or glass transition temperature (Tg for an amorphous polymer) lower than 125° C. have exhibited useful mechanical integrity, however. Jetting of thermosetting resins is a particularly troublesome process due to the fact that any residual resin could eventually get cured and hardened in any location along the path from the resin reservoir to the nozzle orifice. These resins, once thermally cured or radiation-hardened, can no longer be soluble in any solvent and cannot be melted again, making it impossible to clean up or remove. The nozzles or the whole inkjet printhead assembly would then have to be discarded.

In the U.S. Pat. No. 5,257,657 cited earlier, Gore adapted the BPM technique for deposition of metal droplets. In a series of patents (e.g., U.S. Pat. No. 5,617,911, April 1997), Sterett, et al. disclosed a method and apparatus for building metal objects by supplying, aligning and depositing nearly uniform metal melt droplets. Metal droplet stream modeling was developed by Orme and Muntz (e.g., U.S. Pat. No. 5,340,090, August 1994). In U.S. Pat. No. 5,266,098 (Nov. 30, 1993), Chun and Passow disclosed a process for producing charged, uniformly sized metal droplets. These metal droplet based SFF processes do not lend themselves for the fabrication of multi-color objects. The ejection of droplets from a vibrating or ultrasonic driven ejection device requires the liquid to have a relatively low viscosity. Such an ejection device would be good for the droplet ejection of thermosetting resins and metal melts which exhibit low viscosity values, but not for droplet ejection of fully polymerized thermoplastic melts that are normally highly viscous.

In the present invention, a distinct type of material compositions is used in a SFF process based on a droplet ejection device such as an inkjet printhead or a vibration-driven head. In the inkjet printing type SFF process, the dispensing of the material composition can be achieved at a relatively low temperature (e.g., lower than 125° C.). The solidification of the material composition does not require either a high energy radiation source (like in the case of UV-curable resins) to achieve a cured state, or a great amount of heat energy to melt the material at a relatively high temperature and then a cooling means to help solidify the material (like in the case of fully polymerized thermoplastics). Instead, the build material composition is formulated to contain a lower molecular weight reactive precursor to a high polymer. Such a polymer precursor, with a relatively low melting point and low melt viscosity, is hereinafter referred to as a “prepolymer”. A prepolymer normally has a melting point higher than room temperature (Tm>23° C.) and, therefore, remains to be a solid material for easy handling at room temperature. The prepolymer, when heated to above its melting point, acts to make the build material composition in a fluent state prior to being ejected. A range of prepolymers, being of low melting point, can be made to become a liquid at a temperature Tₗ being sufficiently low (e.g., Tₗ<120° C.) while residing in a liquid chamber of an inkjet printhead that the piezo-electric actuator element would not be thermally degraded. This would not be possible if a fully polymerized thermoplastic were used due to a high viscosity and high Tm or Tg.

Two main strategies can be employed to heat treat the material composition after being dispensed from a droplet ejection device. In the first strategy, after being dispensed, the droplets containing the prepolymer are heated to a fast-reacting temperature (Tr) to advance the chain-extension polymerization (without cross-linking) in such a fashion that the melting point (Tₘ^{p}) of the resulting polymer quickly becomes higher than the reaction temperature (Tₘ^{P}>Tr). In this manner, the build material quickly reaches a sufficiently rigid state, making it possible for multiple layers of materials to be stacked together and bonded to one another with a minimal part distortion. Prepolymers prepared from the ring-opening polymerization provide a good example for use in this strategy.

In a second strategy, the object-building zone is maintained at a temperature Tb that is lower than the melting point of the prepolymer (Tb<Tm). The dispensed droplets are quickly frozen or solidified at this build zone temperature, Tb. Upon completion of an individual layer, preferably upon completion of all layers, the dispensed and deposited material composition is then heat treated at a temperature Th that is equal to or slightly lower than the prepolymer melting point (Th≦Tm). The conversion of the prepolymer proceeds in solid state so that the dispensed material no longer flows to change the object dimension. Examples of prepolymers that can be utilized to practice this strategy are those prepared from step-growth polymerizations. The melting points of this class of prepolymers or oligomers can be pre-designed to fall into the preferred range of 25° C.<Tm<250° C., and most preferred range of 25° C.<Tm<125° C. As another example, the SFF method may involve the ejection of cyclic oligomer or prepolymer droplets at a slightly higher temperature (e.g., 200° C. to 300° C.) by using a vibrating or ultrasonic driven droplet ejection device. These prepolymers or oligomers, formulated based on the “cyclics” polymer technology, are of much lower viscosity while residing in a droplet ejection device as compared to their higher molecular weight counterparts. Once dispensed out of such a device to form a part of the 3D object being built, these prepolymer droplets can be converted to high molecular weight linear polymers that have excellent strength, toughness, thermal stability, and solvent resistance.

In the presently invented method, since no significant cross-linking reaction occurs to the prepolymer while being converted to a high molecular weight thermoplastic resin, the printhead assembly would not be clogged up with insoluble or un-meltable resin like in the case of thermoset resins. The resulting thermoplastic polymers are of good strength and toughness. In contrast, a cross-linked thermoset resin tends to be very brittle.

### OBJECTS OF THE INVENTION

An object of the present invention is to provide an improved layer-additive method to fabricate a three-dimensional object with good mechanical integrity from a less expensive class of materials in an essentially point-by-point and layer-by-layer manner.

Another object of the present invention is to provide an improved method that can automatically reproduce a 3-D object directly from a computer-generated data file representing this object.

Yet another object of the present invention is to provide a method for producing a 3-D part without the use of a part-specific tooling or human intervention.

A specific object of the present invention is to provide a simple and cost-effective freeform fabrication method for building a 3-D object using a material composition in an easy-to-handle physical state, without using heavy and expensive equipment. This material composition covers a wide range of polymeric materials.

### BRIEF SUMMARY OF THE INVENTION

The above objects are realized by a method which begins with the creation of a computer-aided design (also referred to as a drawing, an image, or a geometry representation) of a three-dimensional object. The method then involves providing a support member by which the object is supported while being constructed. It also involves operating a material dispensing head for dispensing small droplets of a material composition in a fluent state. This material composition includes a reactive prepolymer at a first temperature (Tₗ) higher than the melting point (Tm) of this prepolymer so as to make the material composition in a fluent state while still residing in a liquid chamber or flow path of the dispensing head. The method further includes operating material treatment means disposed near the dispensed droplets for causing the material composition to rapidly achieve a rigid state in which the material composition is substantially solidified and built up in a form of this 3-D object. The ultimate goal of the material treatment procedures is to convert the reactive prepolymer to a higher molecular weight, substantially linear-chain thermoplastic resin with a balance of good mechanical properties. The method also includes operating a computer and machine controller for generating control signals in response to coordinates of the object design and controlling the position of the dispensing head relative to the support member in response to the control signals to control droplet dispensing of the material composition for constructing the object. Specifically, the dispensed material composition is deposited in multiple layers which solidify and adhere to one another to build up the object.

Drive means such as servo motors or stepper motors are provided to selectively move the support member and dispensing head relative to each other in a predetermined pattern along a direction parallel to an X-Y plane defined by first (X) and second (Y) coordinate axes as the material composition is being dispensed to form a layer. After one layer is built, the dispensing head and the support member are moved away from each other in a third (Z) direction by a predetermined layer thickness. The X-, Y-, and Z-directions form a Cartesian coordinate system. The same procedures of moving and droplet dispensing are then repeated to form each successive layer with each layer having its own characteristic shape and dimensions. Such mechanical movements are preferably achieved through drive signals inputted to the drive motors for the support member and the dispensing head from a computer or a controller/indexer (servo means) supported by a computer. The computer may have a CAD/CAM software to design and create the object to be formed. Specifically, the software is utilized to convert the 3-D shape of an intended object into multiple layer data, which is transmitted as drive signals through a controller to the drive motors. Each individual computer-generated layer has its own shape, dimensions, and thickness. It is the combination and consolidation of these constituent layers that form a complete 3-D shape of the object.

In one preferred embodiment, the material treatment means comprise heating means to heat up the dispensed droplets to a second temperature (Tr) being approximately equal to or higher than the first temperature (Tr>Tₗ) so as to rapidly convert the prepolymer to a higher molecular weight thermoplastic resin with a new melting point (Tₘ^{p}) higher than the second temperature (Tₘ^{p}>Tr). Prepolymer materials that can be employed to achieve this goal include nylon-6 oligomers obtained by the ring-opening polymerization. The material composition may include a catalyst and/or accelerator for promoting the conversion of the prepolymer to a higher molecular thermoplastic resin. In this particular example of nylon-6, the prepolymer may contain an activated anionic chain from caprolactam.

In another preferred embodiment, the material treatment means comprise (a) providing a forming environment (in the object-building zone above the support member) with the environment being at a second temperature Tb that is substantially lower than the first temperature Tₗ to facilitate the solidification of the dispensed droplets; and (b) heating means to heat the 3-D object for converting the prepolymer at a third temperature (Th) being approximately equal to or lower than the melting point of the prepolymer (Th≧Tm) so as to execute the conversion procedure in a substantially rigid or solid state. Procedure (b) may be carried out after each layer is deposited, but is preferably carried out after all constituent layers are deposited. This final heat treatment can be carried out in situ on the support member, but is preferably conducted in a separate oven so that the freeform fabrication apparatus can be used to fabricate additional objects. Essentially all oligomers prepared by step-growth polymerizations and “cyclic oilgomer” approaches can be used for this method. The step-growth prepolymer may be selected from the group consisting of oligomer precursors to linear polyester, polyamide, polyurethane, polyimide, polysulfide, and copolymers thereof. The cyclic oligomer may be selected from the group consisting of cyclic organic carbonate, thiocarbonate, heterocarbonate, imide, polyphenylene ether-polycarbonate, ester, amide, etherketone, ethersulfone, and mixtures thereof.

The dispensing head may include a droplet-ejecting device selected from the group consisting of an inkjet print head, a vibration-driven ejection device, an ultrasonic-driven droplet forming device, and a disturbance-modulated droplet device. The inkjet print head preferably operates on a piezoelectric actuator element. The dispensing head may comprise a plurality of droplet-ejecting devices with a plurality of discharge orifices for producing a multiplicity of droplet streams simultaneously or sequentially. The material composition from an orifice may contain one colorant. With a plurality of nozzle orifices ejecting droplets of different material compositions (including different colorants), the presently invented method is capable of fabricating multi-material and multi-color objects.

Applications and Advantages of the Present Invention:

More Versatile Rapid Prototyping:

The present invention provides a simple yet versatile method of rapid prototyping. Due to the versatility of this method, a user of this method is free to choose a reactive prepolymer from a wide spectrum of chemical compositions. A wide range of material compositions may be combined to form an article with a desired combination of physical and chemical properties. The present method is capable of fabricating multi-material and/or multi-color objects of any complex shape in a point-by-point and layer-by-layer fashion under the control of a computer.

More Cost-Effective Model Making:

The present method imposes a minimal constraint on the selection of various material ingredients. For the purpose of creating a concept model, one has a wide range of inexpensive materials at his/her disposal. In contrast, the FDM process requires the preparation of a filamentary feed material that involves a tedious procedure similar to polymer extrusion followed by fiber spinning. The filament is then fed into a nozzle and re-melted to a liquid state. Selective laser sintering requires preparation of ceramic powder particles with thin polymer coatings. These exotic build materials are difficult to prepare and are very expensive. Processes such as stereo lithograph involves laser curing of expensive photo-curable epoxy or acrylic resins (up to US$200 per pound or $440 per kilogram).

Simple and Less Expensive Fabrication Equipment Design:

The presently invented approach makes it possible to have a simple dispensing head design. For instance, fully polymerized thermoplastic melts are normally highly viscous and, hence, difficult to pump, extrude, or eject out of a small orifice due to a high capillarity pressure that must be overcome. The utilization of a prepolymer or oligomer, with a relatively low melting point and of low viscosity will make it easier to prepare a flowable material composition. A wide range of droplet ejection devices can be chosen for use in the present method. Since inkjet printing has been a well-developed technology, it would be advantageous to make use of the piezo-electric driven inkjet print head. Unfortunately, the most commonly used piezo-electric actuator element is based on lead-zirconate-titanate (PZT) ceramic material. This element can only be effectively employed at a temperature up to 125° C. Fortunately, the present invention provides a wide range of reactive prepolymers that form a low-viscosity fluid at a temperature lower than 125° C. These prepolymers can be readily converted to longer-chain, substantially linear polymers that are thermoplastic in nature. Thermoplastic resins are known to have a good balance of toughness, ductility, strength, and stiffness. By using thermoplastic precursor oligomers, the dispensing head nozzle design can be much less complex. No exotic, fancy or complex fluid delivery device is required. This will also make the control and operation of the present SFF system simple and reliable.

It may be further noted that, in principle, a thermosetting resin can also have a low viscosity before curing and, therefore, can be easily dispensed into a droplet form. Thermoset resins suffer from the at least three shortcomings, however. First, fast-curing thermosetting resins normally require curing by a high energy radiation source (e.g., photocurable epoxy by a laser beam). Second, thermoset resins, once heated, would gradually get cured and tend to clog up the nozzle orifice and other portions of a liquid flow path in a dispensing device. The device would have to be discarded since highly cross-linked thermoset resins are not soluble or fusable (intractable), making it extremely difficult if not impossible to clean up the flow path and remove the clog. Third, the thermoset resins are normally much more brittle and, therefore, the resulting 3-D objects are of poor mechanical integrity.

These and other advantages of the invention will become readily apparent as one reads through the following description of preferred embodiments and the accompanying drawings.

### BRIEF DESCRIPTION OF THE DRAWINGS

FIG. 1 Schematic of a layer manufacturing system.

FIG. 2 Schematic of a piezo-electric inkjet printhead used as a droplet-dispensing head for building a 3-D object layer by layer.

FIG. 3 Schematic of a vibration based droplet ejection device used in building a 3-D object layer by layer.

FIG. 4 A flow chart showing the sequence of creating a 3-D object by a CAD software program, establishing layer-by-layer database by layering software, and sending out motion-controlling signals by a computer to the drive motors through a motion controller.

FIG. 5 Schematic of typical relationships between the melting point or glass transition temperature of a growing prepolymer and the step-growth reaction time.

FIG. 6 A well-known relation between the zero-shear viscosity and molecular weight of a polymer. A lower viscosity is more favorable to droplet production.

### DESCRIPTION OF THE PREFERRED EMBODIMENTS

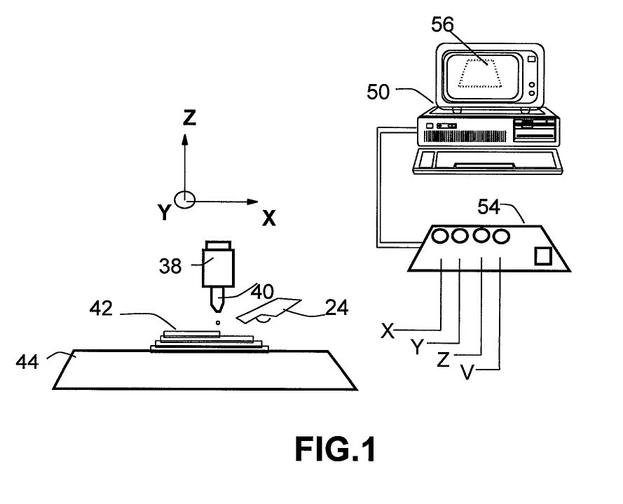

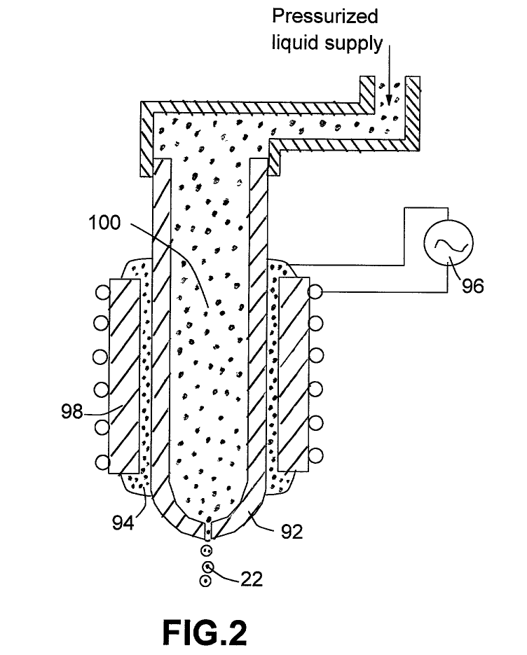

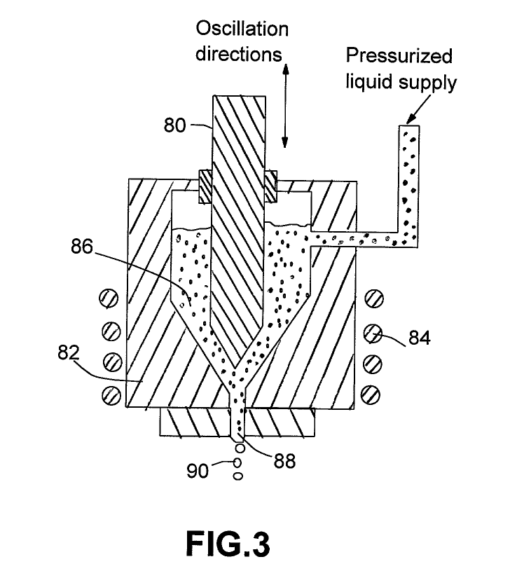

FIG. 1 illustrates one preferred embodiment of the presently invented method for making a three-dimensional (3-D) object. This method begins with the creation of a computer-aided design 56 (a drawing, image, or geometry representation) of a three-dimensional object using a computer 50. This method involves the operation of a system that includes computer software and control hardware (e.g., motion controller/indexer 54). The system further includes a support member 44 by which the object 42 is supported while being constructed. The system also has a material dispensing head 40 for dispensing droplets 22 (FIG. 2) or 90 (FIG. 3) of a material composition in a fluent state. Preferably, this dispensing head comprises an inkjet printhead that is activated by a piezoeletric actuator element 98 (e.g., indicated in FIG. 2) or an ultrasonic- or vibrating-driven droplet ejection device (e.g., indicated in FIG. 3). This material composition includes a low-molecular weight oligomer or prepolymer that helps to make the material composition in a fluent state while still residing in a chamber or reservoir 38 of the material dispensing head 40. A predetermined amount of the material composition may be placed in a reservoir (38 in FIG. 1, 100 in FIG. 2 or 86 in FIG. 3) at a first temperature Tₗ before the build process begins. Alternatively, the material in this reservoir may be supplied, intermittently or continuously, from a material delivery means such as a screw extruder, gear pump, metering pump, positive displacement valve, solenoid-controlled valve, and air pump (pneumatically operated pump). Preferably, the fluent material composition in the reservoir 38 is maintained at an approximately constant pressure, Δp.

In one preferred embodiment, the method further includes operating material treatment means (e.g., a heating device such as a radiant heater or a hot air blower 24) disposed near the deposited droplets of material composition for converting the prepolymer to a longer chain polymer and, hence, causing the material composition to rapidly achieve a rigid state in which the material composition is substantially solidified and built up in a form of this 3-D object. This rapid solidification is achieved by heating the prepolymer droplets to a fast-reacting temperature Tr (Tr≧Tₗ) so as to rapidly advance the chain-extension polymerization (without cross-linking) in such a fashion that the melting point (Tₘ^{p}) of the resulting polymer quickly becomes higher than the reaction temperature (Tₘ^{p}>Tr). Since the environment temperature Tr surrounding the object being built is always lower than the ever-increasing melting point Tₘ^{p} of the growing polymer chains, the dispensed droplets of material composition will always stay in a sufficiently rigid or solid state during the object-building process.

Alternatively, the material treatment means can include (a) providing a build zone temperature (Tb) lower than the softening temperature (Tm or Tg) of the dispensed prepolymer droplets so as to rapidly solidify these droplets (but still allowing sufficient time for the droplets to adhere to one another in the same layer and adhere to the material in a preceding layer); and (b) subjecting the deposited layers to a temperature (Th) substantially close to, but slightly below, the softening temperature in such a manner that the conversion of the prepolymer to a higher molecular weight polymer proceeds essentially in a solid state to avoid any significant shape change. Step (b) may be executed after each layer is deposited, but is preferably done after all constituent layers of the object are deposited.

The method also includes operating a computer 50 for generating control signals in response to coordinates of the design of this object and operating the controller/indexer 54 for controlling the position of the dispensing head relative to the support member in response to the control signals. During the steps of moving the dispensing head relative to the support member, the dispensing head 40 is also controlled to dispense the material composition, continuously or intermittently on demand, for constructing the object 42 while supported with the support member 44. Specifically, the dispensed material composition is deposited in multiple layers which solidify and adhere to one another to build up the object. The line cords X, Y, and Z in FIG. 1 serve to electronically control the X-, Y-, and Z-directional motions of the dispensing head 40 relative to the support member 44 while line cord V serves to control the droplet dispensing operation of the dispensing head.

The fluent material composition may be composed of a prepolymer (in a fluid state), an optional catalyst, an optional reaction promoter or accelerator, and other optional additives such as a colorant. This material composition is capable of solidifying rapidly after being dispensed out of an orifice (e.g., 88 in FIG. 3) at the bottom portion of the dispensing head 40 to deposit onto a surface of a moveable support member 44 (FIG. 1). As indicated earlier, this rapid solidification is made possible by either (a) rapidly advancing the polymerization of the prepolymer droplets in the dispensed material composition into longer-chain thermoplastic resin or (b) quenching the dispensed droplets to a temperature Tb much lower than the Tm of the prepolymer and then advancing the polymer conversion at a temperature Th near or slightly lower than this Tm at a later stage so that this chain extension or polymer conversion procedure takes place in an essentially solid state. In case (a), the process begins with the deposition of a first layer with part or all of the prepolymer being converted to its higher molecular weight counterpart prior to deposition of a second layer. The step of polymer conversion in the first layer could continue when the second and subsequent layers are being built. Similarly, the polymer conversion in the second layer could continue when the third and subsequent layers are being dispensed and deposited. These steps are repeated until all constituent layers of the 3-D object are deposited. At this moment of time, a portion of the prepolymer may possibly still remain as oligomers in the fabricated 3-D shape, which can be subjected to a further treatment at a later stage to complete the polymer conversion process. In case (b), polymer conversion may be allowed to proceed after a layer is built or after several layers are deposited, but most preferably after all layers of the 3-D body are deposited. This treatment may be carried out either in situ above the support member surface in the SFF apparatus or, preferably, in a separate oven after the SFF process is completed. This would allow the SFF apparatus to build additional 3-D bodies while the already SFF-fabricated bodies are being further heat treated in a separate oven.

Material Compositions and Treatment Conditions:

The discharged material composition that comes in contact with the support member or a previous layer must meet two conditions. The first condition is that this material must quickly exhibit a sufficiently high viscosity to prevent excessive flow (or spreading) when being deposited; this is required in order to achieve a good dimensional accuracy. The second condition is that the newly discharged material must be able to adhere to a previous layer. These two conditions can be met by discharging the following material compositions containing three major types of prepolymers that can be rapidly converted to linear polymers of relatively high molecular weights.

Type I Prepolymers (Oligomers Prepared by the Step-Growth Polymerization):

The first type of prepolymer used in the present invention is the low molecular weight oligomers prepared by the step-growth polymerization. The present step-growth polymerizations fall into two groups depending on the type of monomers employed. The first involves two different bi-functional monomers in which each monomer possesses only one type of functional group. The second involves a single bi-functional monomer containing both types of functional groups. For instance, polyamides can be obtained from the reaction of diamines with diacids:

nH₂N—R—NH₂+nHOOC—R′—COOH→H—(NH—R—NHCO—R′—CO)ₙOH+(2n−1)H₂O (Eq.1)

or from the reaction of amino acids with themselves:

nH₂N—R—COOH→H—(NH—R—CO)ₙ—OH+(n−1)H₂O (Eq.2)

where the chain linkage groups R and R′ are typically selected from methylene groups —(CH₂₎ₓ—. Another example of the step-growth polymerization is the preparation of polyester from a diol and a diacid:

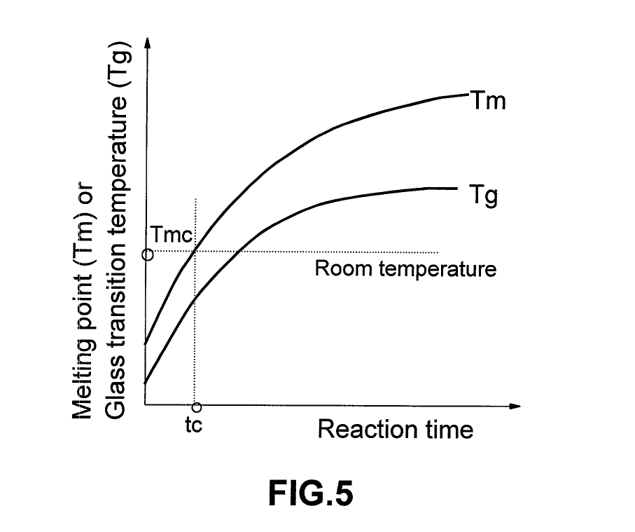

nHO—R—OH+nHOOC—R′—COOH→H—(O—R—OCO—R′—CO)ₙ—OH+(2n−1)H₂O (Eq.3)

where R and R′ can be selected from both aliphatic groups such as methylene or ether linkage and/or aromatic groups. A well-known feature of step-growth polymerizations is that the molecular weight (Mw) of the growing polymer chains increases steadily as a function of reaction time or extent of reaction, p. Furthermore, the melting point (Tm) or glass transition temperature (Tg) of the resulting polymer increases with the increasing chain length or molecular weight. This normally leads to the monotonically increasing relations of Tm (for a semi-crystalline polymer) and Tg (for an amorphous thermoplastic polymer) with respect to the reaction time as schematically indicated in FIG. 5.

Since the molecular weight, Tm, and Tg of the growing chains are a function of the reaction time, the desired Mw, Tm, and Tg can be obtained by quenching the reaction (e.g., by cooling the reacting mass) at the appropriate time (e.g., by selecting a time t>tc in FIG. 5). Conventional wisdom has it that this is not a desirable approach to the control of these desirable physical properties (Mw, Tm, and Tg). This is because the polymer obtained in this manner is unstable in that subsequent heating (back to room temperature or an end-use temperature, e.g.) leads to changes in Mw due to the polymer chain ends containing functional groups which can react further with each other. This statement is valid provided that the polymer obtained would be used as synthesized, without a further treatment. In the present invention, however, this quenching approach can be effectively used to prepare a prepolymer or oligomer with predetermined Mw, Tm and Tg characteristics so that the prepolymer would be in a low-viscosity state for droplet ejection at a proper temperature (e.g., lower than 125° C. by an inkjet printhead). Specific manners in which one can take advantage of this quenching approach are explained as follows:

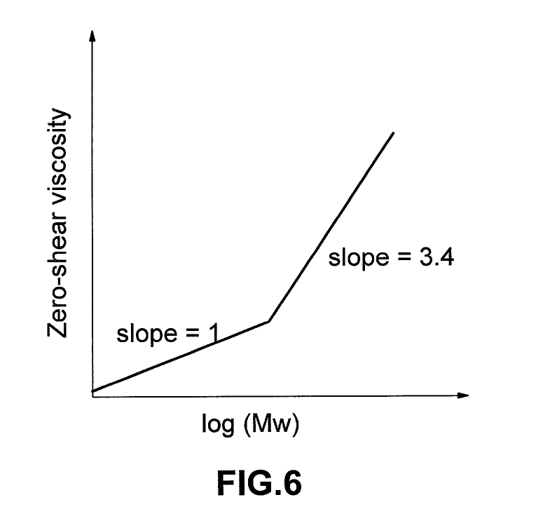

In one preferred embodiment of the present invention, referring again to FIG. 5, a prepolymer can be obtained by allowing the step-growth polymerization to proceed to an extent that the resulting prepolymer has a Tm (if crystalline polymer) or Tg (if amorphous polymer) greater than room temperature (25° C.) and then rapidly cool down (quench) the reacting mass to a temperature much lower than the room temperature to essentially “freeze” the polymerization reactions. This prepolymer is maintained at room temperature or below (so that it is in a solid state for easy handling) prior to being introduced into the resin reservoir in an ejection device such as an inkjet printhead. When it is ready to begin the freeform fabrication process, the resin reservoir may be heated to slightly above the Tm or Tg of the prepolymer to reach a low-viscosity state. The prepolymer melt is of low viscosity because it has a relatively low molecular weight. A well-known relationship between the viscosity and the Mw of a polymer is schematically shown in FIG. 6. A relatively low viscosity is essential to the successful ejection of liquid droplets by an ejection device.

Further preferably, the Tm or Tg is predetermined to be lower than 125° C. so as to allow for the proper operation of a PZT-based inkjet printhead, without compromising the longevity of the piezo-electric actuator element. This feature is desirable since piezo-electric inkjet printing is a well-developed technology and reasonably priced inkj et printheads are commercially available and can be readily incorporated into a droplet ejection based SFF apparatus.

The droplets once dispensed and deposited to form a part of a layer, may be subjected to further treatments. Two treatment strategies have been successfully implemented. The first includes setting up a high temperature environment at the object-building zone so that rapid solidification of the dispensed droplets is achieved by heating the prepolymer droplets to a fast-reacting temperature that rapidly extends the chain length of the prepolymer. A reaction catalyst and/or accelerator may be added to the prepolymer, prior to droplet ejection, to promote the chain extension reaction. This treatment strategy works only for those prepolymers that undergo fast polymer conversion reactions. The second and more widely applicable strategy involves (a) setting up an object-building zone temperature Tb lower than the softening temperature (Tm or Tg) of the dispensed prepolymer droplets so as to rapidly solidify these droplets; and (b) upon completion of the multi-layer deposition process, subjecting the deposited layers to a temperature slightly below the softening temperature for converting the prepolymer to a high molecular weight polymer. This final conversion of linear polymer can proceed in the solid state at a reasonable rate. This solid state reaction does not inflict any significant shape change to the 3-D object. This heat treatment temperature can be allowed to go up with treatment time in accordance with the softening point of the growing chains which normally increases with the extent of reaction, as indicated in FIG. 5. This approach of steadily increasing heat treatment temperature helps reduce the time required for completing the chain extension process.

### EXAMPLE 1

### Polyesterification of Adipic Acid (—R′—=—(CH₂)₄— in Eq.3) with Diethylene Glycol (—R—=—(CH₂)₂—O—(CH₂)₂— in Eq.3) at 109° C. Catalyzed by 0.4 mole % p-toluenesulfonic Acid.

A prepolymer, polyester oligomer, was obtained by allowing the above reactant mixture to proceed for 10 hours at 109° C. The reacting mass was quenched to a dry ice bath to tentatively freeze the reaction. The resulting oligomer had a degree of polymerization of approximately 75, corresponding to a molecular weight of 8,330 g/mole. The prepolymer was reheated to 70° C. in the resin reservoir of a printhead, which ejects droplets of prepolymer onto a build zone at a temperature of 20° C. The droplets solidified and adhered to each other to build a 3-D body in accordance with the presently invented process. The 3-D body was then further heat treated in an oven at 35° C. for one hour, 45° for two hours, and 55° C. for three hours.

### EXAMPLE 2

### Preparation of Polyamide 6/6 Prepolymer from Hexamethylene Diamine (—R—=—(CH₂)₆— in Eq.1) and Adipic Acid (—R′—=—(CH₂)₄— in Eq.1).

The monomer mixture with a stoichiometric balance of amine and carboxyl groups was heated at 200° C. to produce a 1:1 ammonium salt, or nylon salt. The prepolymer was prepared by heating an aqueous slurry of approximately 70% of the nylon salt at 200° C. in a closed autoclave under a pressure of approximately 15 atmospheres. This direct amidation process proceeded for approximately 2 hours to obtain an approximately 85% prepolymer conversion. The prepolymer bulk was size-reduced to powder form, which was later used and heated in a droplet ejection device. Droplets of this prepolymer were ejected at 285° C. by a vibration-driven droplet ejector onto an object build zone with a Tb=25°-75° C. The solidification of these droplets could be allowed to occur at any temperature Tb lower than 200° C., but preferably lower than 75° C. The resulting multi-layer 3-D object was of sufficiently high toughness and strength for use as a concept model. If a higher mechanical integrity of the 3-D object is desired, the object could be subjected to a final polymer conversion treatment at a temperature of 250-260° C. This solid state conversion process could last for 1-10 hours, depending on the desired molecular weight of the resulting linear high polymer.

### EXAMPLE 3

### Copolymers of Polyethylene Terephthalate and Polyoxyethylene Glycol.

The monomer mixture of dimethyl terephthalate and ethylene glycol at an 1:1 ratio was mixed with a desired amount of polyoxyethylene glycol (Mw=2800 g/mole) and a trace amount of titanium oxide as catalyst. The reacting mass was heated at 200° C. for approximately 4 hours in a vapor bath with the methanol being distilled and collected continuously. The resulting prepolymer was maintained at 275° C. in the resin reservoir of a vibration-driven droplet ejector for a predetermined length of time (between 10 and 60 minutes under a nitrogen blanket). The droplets were then dispensed to an object-building zone at room temperature. The resulting multi-layer body was then placed in a vacuum oven at 200° C. for one hour, 230° C. for two hours, and 250° C. for three hours.

Type 2 Prepolymers (Linear Oligomers Prepared by Ring-Opening Polymerization of Cyclic Monomers):

The second type of prepolymers that can be employed in the present invention are oligomers that are prepared from the ring-opening polymerization of cyclic monomers such as ethers, acetals, esters, amides, amines, sulfides, siloxanes and mixtures thereof. Most ring-opening polymerizations behave as step polymerizations in that the polymer molecular weight increases steadily throughout the course of the polymerization. This implies that the same strategies used in the preparation of step-growing oligomers (Type 1 Prepolymer) for solidification control and polymer conversions can be employed in the ejection and deposition of prepolymer droplets prepared from the ring-opening polymerization of cyclic monomers.

Specifically, the ring-opening polymerization of a cyclic monomer is allowed to proceed to an extent in which the growing chains have predetermined Mw, Tm, and Tg values, with Tm or Tg higher than room temperature but preferably lower than 125° C. The reacting mass is then quenched (e.g., rapidly cooled to liquid nitrogen or dry ice temperatures) to freeze the polymerizing reaction. The prepolymer solid is then heated back to above the Tm or Tg to become a liquid in the resin reservoir of a droplet ejection device just prior to droplet ejection. In one preferred embodiment of the present invention, the ejected and deposited droplets are solidified by providing a lower temperature environment near the object-building zone. Once the 3-D body is made, it is subjected to a polymer conversion treatment at a temperature comparable to (but slightly lower than) the current Tm or Tg of the deposited prepolymer. The prepolymer will be converted to a higher molecular weight polymer under solid state conditions. In another preferred embodiment, the dispensed and deposited droplets are subjected to a fast-reacting temperature Tr, equal to or higher than the droplet ejection temperature, so as to rapidly convert the prepolymer into a high Mw, non-cross-linked polymer and, thereby, solidifying the polymer while the layers are being built.

### EXAMPLES 4a-4d

### Prepolymers for Nylon 6

The production of nylon-6 via ring-opening of ε-caprolactam may begin with the preparation of a prepolymer under the conditions specified in Table 1. Sample 4-a prepolymer was prepared by the sodium hydride-catalyzed ring-opening polymerization of caprolactam at 230° C. for 30 minutes. The reacting mass was quenched to −50° C. for substantially freezing the polymerization. This oligomer sample remains in a solid state at room temperature, 23° C. This prepolymer was blended with a small amount of activator (0.5% N-acylcaprolactam) and the resulting mixture was re-heated back to 100° C. inside the resin reservoir of a droplet ejection device. The prepolymer liquid was ejected at this ejection temperature Te=Tₗ=100° C. out of the printhead to the object-building zone above the support member; this build zone being maintained at Tb=160° C. At this temperature, the dispensed prepolymer droplets underwent a rapid reaction for extending the chain length of the polymer, which became solidified to permit layer-wise build-up of a 3-D body. This 3-D body was then placed in an oven preset at 170° C. to further advance the polymer conversion which took place in a solid state.

TABLE 1
Four examples illustrating the preparation of caprolactam oligomers and
conversion of these oligomers to high molecular weight nylon-6 polymers.

| | | | Ring-opening | Ejection T | Subsequent |
|---|---|---|---|---|---|
| Sample | | | polymerization | and build | treatment |
| No. | Catalyst | Co-catalyst or activator | temperature and time | zone T, ° C. | conditions |
| 4-a | sodium | N-acylcaprolactam, | 230° C. for 30 min.; | Te = 100° C. | 170° C. for 60 |
| | hydride, 1 | 0.5% added after | quenched to −50° C. | Tb = 160° C. | minutes |
| | mol. % | prepolymer was made | | | |
| 4-b | sodium | TMXDI, 0.5% | 80° C. for 10 min., | Te = 100° C. | 80° C. for 30 min., |
| | hydride, | | quenched to −50° C. | Tb = 23° C. | 90° C. for 30 min., |
| | 0.5 mol. % | | | | & 160° C. for |
| | | | | | 1 hour |
| 4-c | TMXDI, 1 | Sodium caprolactamate, | 70° C. for 10 min., | Te = 100° C. | 170° C. for 60 |
| | mol. % | 2 mol. % | quenched to −50° C. | Tb = 160° C. | minutes |
| 4-d | TMI, 1 | Sodium caprolactamate, | 70° C. for 15 min., | Te = 100° C. | 170° C. for 60 |
| | mol. % | 2 mol. % | quenched to −50° C. | Tb = 160° C. | minutes |

Note:
TMXDI = tetramethyl-1,3-xylylene diisocyanate; TMI = 3-isopropenyl dimethylbenzyl isocyanate.

In Example 4b, the prepolymer was prepared by mixing caprolactam monomer with 0.5 mol. % of sodium hydride as a catalyst and 0.5% of TMXDI as an activator. The mixture was allowed to react at 80° C. for 10 minutes prior to being quenched to −50° C. The reacting mass was re-heated to 100° C. prior to being ejected out of a printhead into a build zone at Tb=23° C. for rapid solidification. These solidified prepolymer droplets were deposited and built up layer by layer to form a 3-D body, which was removed from the build zone and placed in an oven for further treatments. A tough nylon-6 object was obtained after a heat treatment schedule of 80° C. for 30 min., 90° C. for 30 min., and 160° C. for 1 hour.

In Example 4-c, caprolactam monomer along with 1 mol. % of TMSDI and 2 mol. % of sodium caprolactam was heated at 70° C. for 10 minutes to produce an oligomer mass, which was quenched to −50° C. This prepolymer sample was re-heated to 100° C. for ejection into droplets which were directed to deposit in a build zone of 160° C. to build up a 3-D object layer by layer. At this temperature, the conversion of oligomers into a large Mw polymer occurred rapidly, presumably pushing the Tm of the resulting polymer above approximately 200° C. Upon completion of a further heat treatment of 170° C. in an oven for 1 hour, the nylon-6 polymer was found to exhibit a Tm of approximately 216° C. In Example 4-d, the catalyst employed was TMI with other preparation and treatment conditions being comparable to those in Example 4-c.

Type 3 Prepolymer (Cyclic Oligomersfrom “Cyclics” Technology):

A third type of prepolymers that can be used in the presently invented method include the cyclic oligomers prepared by a relatively new synthesis approach commonly referred to as the “cyclics” technology developed primarily by scientists at the General Electric Co. This technology was disclosed in the following U.S. Pat. No. 4,644,053 (Feb. 17, 1987 to Brunelle, et al.), U.S. Pat. No. 4,696,998 (Sep. 29, 1987 to Brunelle, et al.), U.S. Pat. No. 4,837,298 (Jun. 6, 1989 to Celia, et al.), U.S. Pat. No. 4,789,725 (Dec. 6, 1988 to Guggenheim, et a.), U.S. Pat. No. 4,757,132 (Jul. 12, 1988 to Brunelle, et al.), U.S. Pat. No. 4,808,754 (Feb. 28, 1989 to Guggenheim, et al.), U.S. Pat. No. 4,736,016 (Apr. 5, 1988 to Brunelle, et al.), U.S. Pat. No. 4,980,453 (Dec. 25, 1990 to Brunelle, et al.), U.S. Pat. No. 4,880,899 (Nov. 14, 1989 to Guggenheim, et al.), U.S. Pat. No. 4,853,459 (Aug. 1, 1989 to Stewart), U.S. Pat. No. 4,829,144 (May 9, 1989 to Brunelle, et al.), U.S. Pat. No. 4,814,429 (Mar. 21, 1989 to Silva), and U.S. Pat. No. 4,927,904 (May 22, 1990 to Guggenheim, et al.). These cyclic oligomers cover a wide range of chemical linkages including cyclic organic carbonate, thiocarbonate, heterocarbonates (containing linkages such as ester, urethane, imide, ether sulfone, ether ketone, or amide), imides, polyphenylene ether-polycarbonate, esters, amides, etherketones, ethersulfones, and mixtures thereof.

These cyclic oligomers have the following common features that make them particularly well-suited for use in the present freeform fabrication method: (1) these oligomers have melting points higher than room temperature (normally 140° C.<Tm<300° C.; mostly between 200° and 250° C.); (2) presumably due to the ease of oligomer cyclics sliding over one another, they have a relatively low viscosity at T>Tm; and (3) they can be easily converted to high molecular weight linear polymers or copolymers with excellent mechanical, physical, and chemical properties. These features have made it possible to carry out freeform fabrication of 3-D objects according to the following general procedures: (i) heating a cyclic oligomer sample above its melting point, introducing this liquid to a droplet ejection device, and optionally adding any catalyst and/or accelerator for the subsequent polymerization; (ii) dispensing the oligomer droplets to an object-building zone at room temperature (or at any temperature substantially lower than the Tm of the oligomer) to facilitate fast solidification and formation of a 3-D body essentially point by point and layer by layer; and (iii) subjecting the resulting 3-D body to a further treatment that includes heating the 3-D body at a temperature just below the Tm of this oligomer so as to undergo a solid state conversion of the oligomer to a high Mw thermoplastic material. These procedures are similar to the procedures used in the case of Type 1 Prepolymer because, after all, the preparation of the resulting polymers went through essentially step-wise growth mechanisms.

Processes and Needed Hardware:

Referring to FIG. 1-FIG. 3, the process involves intermittently or continuously dispensing droplets of the fluent material composition through an orifice of a dispensing head 40 to deposit onto a surface of a support member 44. During this dispensing procedure, the support member and the dispensing head are moved (preferably under the control of a computer 50 and a controller/indexer 54) with respect to each other along selected directions in a predetermined pattern on an X-Y plane defined by first (X-) and second (Y-) directions and along the Z-direction perpendicular to the X-Y plane. The three mutually orthogonal X-, Y- and Z-directions form a Cartesian coordinate system. These relative movements are effected so that the material composition can be deposited essentially point by point and layer by layer to build a multiple-layer object according to a computer-aided design (CAD) drawing of a 3-D object.

In one preferred embodiment, an optional heating provision (e.g., heating elements) is attached to, or contained in, the dispensing head to control the physical and chemical state of the material composition; e.g., to help maintain it in a fluent state. A temperature sensing means (e.g. a thermocouple) and a temperature controller can be employed to regulate the temperature of the dispensing head. Heating means are well known in the art.

Advantageously, the dispensing head may be designed to comprise a plurality of discharge orifices. Several commercial sources provide inkjet printheads that feature from several hundred to more than 1,500 discharge orifices. In another embodiment of the presently invented method, the dispensing head may comprise a plurality of inkjet print heads, each comprising a single orifice or a plurality of discharge orifices. Such a multiple-printhead dispensing system is desirable because an operator may choose to use different material compositions to build different portions of an object. Different material compositions could include different colorants. There are many commercially available inkjet print heads that are capable of dispensing the material compositions in the presently invented method. Examples include those supplied by the Lee Company (Westbrook, Conn., USA), Tektronix (Beavorton, Oreg., USA), and Spectra, Inc. (Keene, N.H., USA). A single-orifice piezo-electric based printhead is schematically shown in FIG. 2, in which the inkjet tip assembly is comprised of a nozzle 92 body and a ceramic piezo-electric element 98 which are themselves operatively interconnected by anchoring medium 94. The nozzle body 92 has a liquid reservoir 100 to receive the material composition from a material supply under a pressure. This pressure is large enough to quickly refill the assembly with the liquid material composition, but not large enough to force the liquid from the nozzle without assistance from the piezo-electric element. An oscillating voltage source 96 applies an oscillating driving voltage across the inside and outside surfaces of the piezo-electric element 98, causing the element to expand or contract. Each contraction of the piezo-electric element causes a drop 22 of the liquid material composition to be ejected from an outlet orifice of the nozzle.

The droplet-ejecting devices may also be selected from ultrasonic-driven, vibration-driven, or disturbance-modulated devices. These devices are known in the art; e.g., U.S. Pat. No. 3,222,776 (Dec. 14, 1965 to R. J. Kawecki), U.S. Pat. No. 5,257,657 (Nov. 2, 1993, to D. W. Gore), U.S. Pat. No. 5,266,098 (Nov. 30, 1993 to Chun, et al.), and U.S. Pat. No. 5,259,593 (Nov. 9, 1993 to Orme, et al.). A simple vibration-driven droplet-ejecting device is schematically shown in FIG. 3, in which a nozzle body 82 has a liquid reservoir 86 terminating at a discharge orifice 88 of a predetermined size. The reservoir is equipped with heating means (e.g., heating elements 84) to maintain the material composition in a fluent state. The reservoir is in flow communication with a pressurized liquid material supply (e.g., a gear pump or screw extruder). A drive shaft 80, concentrically aligned with the liquid reservoir 86, is driven by an actuator signal to oscillate up and down. When this drive shaft oscillates downward, it expels droplets 90 of liquid material out through the orifice 88. When the shaft moves upward, the pressurized fluid supply quickly refill the reservoir 86.

Referring again to FIG. 1, the support member 44 is located in close, working proximity to (at a predetermined initial distance from) the dispensing head 40. The upper surface of the support member preferably has a flat region sufficiently large to accommodate the first few layers of deposited material composition. The support member and the dispensing head are equipped with mechanical drive means for moving the support member relative to the movable dispensing head in three dimensions along “X,” “Y,” and “Z” axes in a predetermined sequence and pattern, and for displacing the dispensing head a predetermined incremental distance relative to the support member. This can be accomplished, for instance, by allowing the support member and the dispensing head to be driven by three separate linear motion devices, which are powered by three stepper motors. Linear motion devices and X-Y-Z gantry tables are commercially available. Z-axis movements are effected to displace the nozzle relative to the support member and, hence, relative to each layer deposited prior to the start of the formation of each successive layer. This will make it possible to form multiple layers of predetermined thicknesses, which build up on each other sequentially as the material composition solidifies after being discharged from the orifice. Instead of stepper motors, many other types of drive means can be used, including linear motors, servo motors, synchronous motors, D.C. motors, and fluid motors.

As another preferred embodiment of the present invention, the apparatus used for the process may comprise a plurality of dispensing heads (e.g., 5 print heads for 5 different colorants: white, black, blue, yellow and red) each having flow-passage means (chamber or channel) therein connected to a dispensing orifice at one end thereof. Each additional nozzle is provided with a separate supply of a different material composition, and means for introducing this material composition into the flow-passage so that the material composition is in a fluent state just prior to discharge. Each print head can have one discharge orifice or a multiplicity of discharge orifices.

Another embodiment of the present invention involves using a multiple-nozzle apparatus as just described. However, at least one nozzle is supplied with a material for depositing a support structure for supporting those portions or features of the 3-D object that cannot support themselves (e.g., overhangs and isolated islands). The support material used may be a low melting point materials such as wax for easy removal at a later stage.

Computer-Aided Design and Process Control:

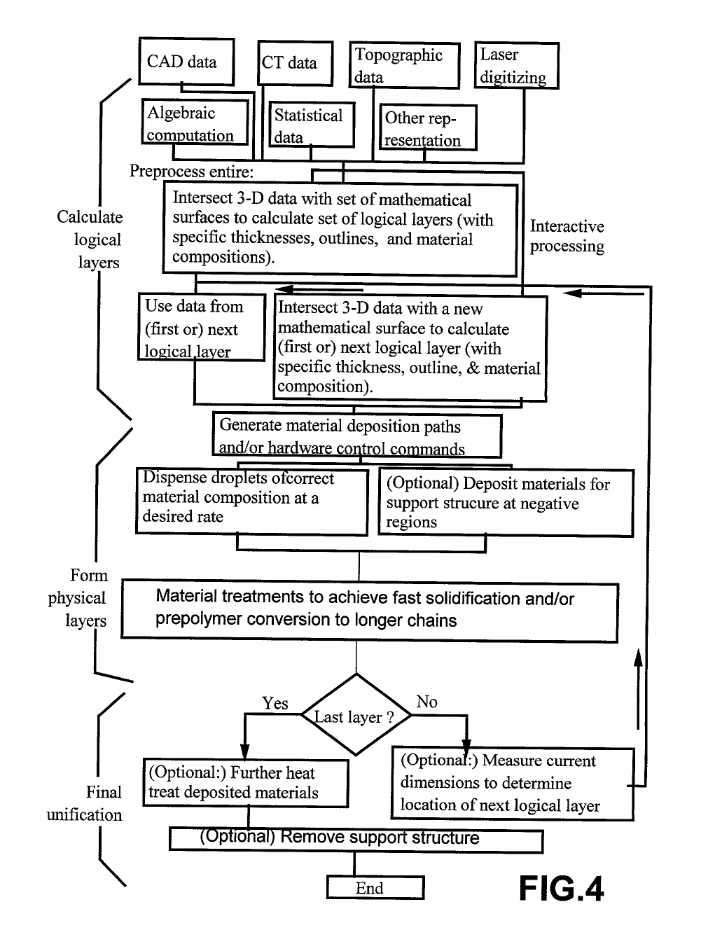

A preferred embodiment of the present invention is a solid freeform fabrication method in which the execution of various steps may be illustrated by the flow chart of FIG. 4. The method begins with the creation of a mathematical model (e.g., via computer-aided design, CAD), which is a data representation of a 3-D object. This model is stored as a set of numerical representations of layers which, together, represent the whole object. A series of data packages, each data package corresponding to the physical dimensions and shape of an individual layer, is stored in the memory of a computer in a logical sequence.

In one preferred approach, before the constituent layers of a 3-D object are formed, the geometry of this object is logically divided into a sequence of mutually adjacent theoretical layers, with each theoretical layer defined by a thickness and a set of closed, nonintersecting curves lying in a smooth two-dimensional (2-D) surface. These theoretical layers, which exist only as data packages in the memory of the computer, are referred to as “logical layers.” This set of curves forms the “contour” of a logical layer or “cross section”. In the simplest situation, each 2-D logical layer is a plane so that each layer is flat, and the thickness is the same throughout any particular layer. However, this is not necessarily so in every case, as a layer may have any desired curvature and the thickness of a layer may be a function of position within its two-dimensional surface. The only constraint on the curvature and thickness function of the logical layers is that the sequence of layers must be logically adjacent. Therefore, in considering two layers that come one after the other in the sequence, the mutually abutting surfaces of the two layers must contact each other at every point, except at such points of one layer where the corresponding point of the other layer is void of material as specified in the object model.

As summarized in the top portion of FIG. 4, the data packages for the logical layers may be created by any of the following methods:

(1) For a 3-D computer-aided design (CAD) model, by logically “slicing” the data representing the model,

(2) For topographic data, by directly representing the contours of the terrain,

(3) For a geometrical model, by representing successive curves which solve “z =constant” for the desired geometry in an x-y-z rectangular coordinate system, and

(4) Other methods appropriate to data obtained by computer tomography (CT), magnetic resonance imaging (MRI), satellite reconnaissance, laser digitizing, line ranging, or other reverse engineering methods of obtaining a computerized representation of a 3-D object.

An alternative to calculating all of the logical layers in advance is to use sensor means to periodically measure the dimensions of the growing object as new layers are formed, and to use the acquired data to help in the determination of where each new logical layer of the object should be, and possibly what the curvature and thickness of each new layer should be. This approach, called “adaptive layer slicing”, could result in more accurate final dimensions of the fabricated object because the actual thickness of a sequence of stacked layers may be different from the simple sum of the intended thicknesses of the individual layers.

The closed, nonintersecting curves that are part of the representation of each layer unambiguously divide a smooth two-dimensional surface into two distinct regions. In the present context, a “region” does not mean a single, connected area. Each region may consist of several island-like subregions that do not touch each other. One of these regions is the intersection of the surface with the desired 3-D object, and is called the “positive region” of the layer. The other region is the portion of the surface that does not intersect the desired object, and is called the “negative region.” The curves that demarcate the boundary between the positive and negative regions, and are called the “outline” of the layer. In the present context, the material composition is allowed to be deposited in the “positive region” while, optionally, a wax or a low-melting material may be deposited in certain parts or all of the “negative region” in each layer to serve as a support structure.

As a specific example, the geometry of a three-dimensional object may be converted into a proper format utilizing commercially available CAD/Solid Modeling software. A commonly used format is the stereo lithography file (.STL), which has become a defacto industry standard for rapid prototyping. The object image data may be sectioned into multiple layers by a commercially available software program. Each layer has its own shapes and dimensions, which define both the positive region and the negative region. These layers, each being composed of a plurality of segments, when combined together, will reproduce a shape of the intended object.

In one embodiment of the present invention, the method involves depositing a lower-melting material in all of the negative regions in each layer to serve as a support structure. This support structure may be removed at a later stage or at the conclusion of the object-building process. The presence of a support structure (occupying the negative region of a layer), along with the object-building material (the positive region), will completely cover a layer before proceeding to build a subsequent layer.

As another embodiment of the present invention, the 3-D object making process comprise additional steps of (1) evaluating the data files of the CAD drawing representing the intended object to locate any unsupported feature of the object and (2) responsive to this evaluation step, determining a support structure for the un-supported feature. This can be accomplished by, for instance, (a) creating a plurality of segments defining the support structure, (b) generating programmed signals corresponding to each of the segments defining this support structure in a predetermined sequence; and (c) operating a separate material deposition device, in response to these programmed signals for building the support structure.

When a multi-material object is desired, these segments are preferably sorted in accordance with their material compositions. This can be accomplished by taking the following procedure:: When the stereo lithography (.STL) format is utilized, the geometry is represented by a large number of triangular facets that are connected to simulate the exterior and interior surfaces of the object. The triangles may be so chosen that each triangle covers one and only one material composition. In a conventional .STL file, each triangular facet is represented by three vertex points each having three coordinate points, (x₁,y₁,z₁), (x₂,y₂,z₂) and (x₃,y₃,z₃), and a unit normal vector (i,j,k). Each facet is now further endowed with a material composition code to specify the desired material composition. This geometry representation of the object is then sliced into a desired number of layers expressed in terms of any desired layer interface format (such as Common Layer Interface or CLI format). During the slicing step, neighboring data points with the same material composition code on the same layer may be sorted together. These segment data in individual layers are then converted into programmed signals (data for selecting dispensing heads and tool paths) in a proper format, such as the standard NC G-codes commonly used in computerized numerical control (CNC) machinery industry. These layering data signals may be directed to a machine controller which selectively actuates the motors for moving the dispensing head with respect to the support member, activates signal generators, drives the material supply means (if existing) for the dispensing head, drives the optional vacuum pump means, and operates optional temperature controllers, etc. It should be noted that although .STL file format has been emphasized in this paragraph, many other file formats have been employed in different commercial rapid prototyping and manufacturing systems. These file formats may be used in the presently invented system and each of the constituent segments for the object geometry may be assigned a material composition code if an object of different material compositions at different portions is desired.

The three-dimensional motion controller is electronically linked to the mechanical drive means and is operative to actuate the mechanical drive means (e.g., those comprising stepper motors) in response to “X”, “Y”, “Z” axis drive signals for each layer received from the CAD computer. Controllers that are capable of driving linear motion devices are commonplace. Examples include those commonly used in a milling machine.

Numerous software programs have become available that are capable of performing the presently specified functions. Suppliers of CAD/Solid Modeling software packages for converting CAD drawings into .STL format include SDRC (Structural Dynamics Research Corp. 2000 Eastman Drive, Milford, Ohio 45150), Cimatron Technologies (3190 Harvester Road, Suite 200, Burlington, Ontario L7N 3N8, Canada), Parametric Technology Corp. (128 Technology Drive, Waltham, Mass. 02154), and Solid Works (150 Baker Ave. Ext., Concord, Mass. 01742). Optional software packages may be utilized to check and repair .STL files which are known to often have gaps, defects, etc. AUTOLISP can be used to convert AUTOCAD drawings into multiple layers of specific patterns and dimensions.

Several software packages specifically written for rapid prototyping have become commercially available. These include (1) SOLIDVIEW RP/MASTER software from Solid Concepts, Inc., Valencia, CA; (2) MAGICS RP software from Materialise, Inc., Belgium; and (3) RAPID PROTOTYPING MODULE (RPM) software from Imageware, Ann Arbor, Michigan. These packages are capable of accepting, checking, repairing, displaying, and slicing .STL files for use in a solid freeform fabrication system. MAGICS RP is also capable of performing layer slicing and converting object data into directly useful formats such as Common Layer Interface (CLI). A CLI file normally comprises many “polylines” with each polyline being an ordered collection of numerous line segments. These and other software packages (e.g. Bridgeworks from Solid Concepts, Inc.) are also available for identifying an un-supported feature in the object and for generating data files that can be used to build a support structure for the un-supported feature. The support structure may be built by a separate fabrication tool or by the same dispensing head that is used to build the object.

A company named CGI (Capture Geometry Inside, currently located at 15161 Technology Drive, Minneapolis, Minn.) provides capabilities of digitizing complete geometry of a three-dimensional object. Digitized data may also be obtained from computed tomography (CT) and magnetic resonance imaging (MRI), etc. These digitizing techniques are known in the art. The digitized data may be re-constructed to form a 3-D model on the computer and then converted to .STL files.

Sensor means may be attached to proper spots of the support member or the material deposition device (e.g., dispensing head) to monitor the physical dimensions of the physical layers being deposited. The data obtained are fed back periodically to the computer for re-calculating new layer data. This option provides an opportunity to detect and rectify potential layer variations; such errors may otherwise cumulate during the build process, leading to significant part inaccuracy. Many prior art dimension sensors may be selected for use in the present apparatus.

As indicated earlier, the most popular file format used by all commercial rapid prototyping machines is the .STL format. The .STL file format describes a CAD model's surface topology as a single surface represented by triangular facets. By slicing through the CAD model simulated by these triangles, one would obtain coordinate points that define the boundaries of each cross section. It is therefore convenient for a dispensing head to follow these coordinate points to trace out the perimeters (peripheral contour lines) of a layer cross section. These perimeters may be built with selected material composition patterns. These considerations have led to the development of another embodiment of the present invention. This is a method as set forth in the above-cited process, wherein the moving step includes the step of moving the dispensing head and the support member relative to one another in a direction parallel to the X-Y plane according to a first predetermined pattern to form an outer boundary of one selected material composition or a distribution pattern of different material compositions onto the support member. The outer boundary defines an exterior surface of the object.

Another embodiment is a process as set forth in the above paragraph, wherein the outer boundary defines an interior space in the object, and the moving step further includes the step of moving the dispensing head and the base member relative to one another in one direction parallel to the X-Y plane according to at least one other predetermined pattern to partially or completely fill this interior space with a selected material composition. The interior space does not have to have the same material composition as the exterior boundary. The interior space may be built with materials of a spatially controlled composition comprising one or more distinct types of materials. The material compositions may be deposited in continuously varying concentrations of distinct types of materials. This method may further comprise the steps of (1) creating a geometry of the object on a computer with the geometry including a plurality of segments defining the object and materials to be used; and (2) generating program signals corresponding to each of these segments in a predetermined sequence, wherein the program signals determine the movement of the dispensing head and the support member relative to one another in the first predetermined pattern and at least one other predetermined pattern.

We claim:

1. A freeform fabrication method for making a three-dimensional object from a design created on a computer, comprising:
(a) providing a support member by which said object is supported while being constructed;
(b) operating a droplet dispensing head for dispensing droplets of a material composition in a fluent state at a first temperature onto said support member, said material composition comprising a reactive prepolymer with a melting point above 23° C. and said first temperature being greater than said melting point;
(c) operating material treatment means disposed a distance from said dispensed droplets of material composition for causing said material composition to rapidly achieve a rigid state in which said material composition is substantially solidified and built up in a form of said three-dimensional object, said material treatment means comprising means for converting said reactive prepolymer to a thermoplastic resin; and
(d) operating control means for generating control signals in response to coordinates of said design of said object and controlling the position of said dispensing head relative to said support member in response to said control signals to control dispensing of said material composition for constructing said object.

2. A method of claim 1 wherein said material treatment means comprise heating means to heat up said dispensed droplets to a second temperature being approximately equal to or higher than said first temperature so as to rapidly convert said prepolymer in said dispensed droplets to a higher molecular weight thermoplastic resin with a melting point substantially higher than said second temperature.

3. A method of claim 1 wherein said material treatment means comprise (a) means for providing a forming environment above said support member with said environment being at a second temperature that is substantially lower than said first temperature to facilitate the solidification of said dispensed droplets; and (b) heating means to heat said 3-D object being built for converting said prepolymer to a higher molecular weight thermoplastic resin at a third temperature being approximately equal to or lower than the melting point of said prepolymer so as to execute said conversion procedure in a substantially rigid or solid state.

4. A method of claim 1 wherein said dispensing head comprises a droplet-ejecting device selected from the group consisting of an inkjet print head, a vibration-driven ejection device, an ultrasonic-driven droplet forming device, and a disturbance-modulated droplet device.

5. A method of claim 1 wherein said material composition includes a catalyst and/or accelerator for promoting the rapid conversion of said prepolymer to a higher molecular weight thermoplastic resin.

6. A method of claim 1 wherein said control means include servo means for indexing and positioning said dispensing head relative to said support member.

7. A method of claim 4 wherein said inkjet print head operates with a piezoelectric actuator element.

8. A method of claim 3 wherein said prepolymer is prepared by using a step-growth polymerization.

9. A method of claim 1 wherein said prepolymer is selected from the group consisting of oligomer precursors to linear polyester, polyamide, polyurethane, polyimide, polysulfide, and copolymers thereof.

10. A method of claim 1 wherein said prepolymer is prepared by using a ring-opening polymerization.

11. A method of claim 1 wherein said prepolymer comprises a cyclic oligomer.

12. A method of claim 11 wherein said cyclic oligomer is selected from the group consisting of cyclic organic carbonate, thiocarbonate, heterocarbonate, imide, polyphenylene ether-polycarbonate, ester, amide, etherketone, ethersulfone, and mixtures thereof.

13. A method of claim 1 wherein said material composition comprises a colorant.

14. A method of claim 10 wherein said prepolymer contains an activated anionic chain from caprolactam.

15. A method of claim 1 wherein said dispensing head comprises a plurality of droplet ejection heads.

16. A method of claim 1, wherein said dispensing head comprises a plurality of nozzle orifices.

17. A freeform fabrication method for making a three-dimensional object comprising:
(a) providing at least one material composition in a fluent state, said composition comprising a reactive prepolymer;
(b) feeding said at least one material composition to a dispensing head with at least one discharge orifice of a predetermined size;
(c) dispensing droplets of said at least one material composition on demand from said dispensing head onto a support member disposed at a predetermined initial distance from said dispensing head;
(d) operating material treatment means for further extending the chain length of said prepolymer in said dispensed droplets to obtain a higher molecular weight thermoplastic resin; and
(e) during said dispensing step, moving said dispensing head and said support member relative to one another in a plane defined by first and second directions and in a third direction orthogonal to said plane to form said at least one material composition into a three-dimensional shape of said object.

18. A freeform fabrication method of claim 17, wherein said dispensing head has at least two discharge orifices for dispensing at least two different material compositions for building a multi-material object.

19. A freeform fabrication method of claim 17, further including the step of operating said dispensing head or a separate dispensing device for building a support structure for an un-supported feature of said object.

20. A freeform fabrication method of claim 17, wherein said moving step includes the steps of moving said dispensing head and said support member relative to one another in a direction parallel to said plane to form a first layer of said at least one material composition on said support member, moving said dispensing head and said support member away from one another in said third direction by a predetermined layer thickness distance, and dispensing a second layer of said at least one material composition onto said first layer while simultaneously moving said dispensing head and said support member in said direction parallel to said plane, whereby said second layer adheres to said first layer.

21. A freeform fabrication method of claim 20, further including the steps of forming multiple layers of said at least one material composition on top of one another by repeated dispensing of said at least one material composition as said dispensing head and said support member are moved relative to one another in one direction parallel to said plane, with said dispensing head and said support member being moved away from one another in said third direction by a predetermined layer thickness after each preceding layer has been formed.

22. A freeform fabrication method of claim 17, further including the steps of: creating a geometry representation of said three-dimensional object on a computer, said
geometry representation including a plurality of segments defining said object;
generating programmed signals corresponding to each of said segments in a predetermined sequence; and
moving said dispensing head and said support member relative to one another in response to said programmed signals.

23. A freeform fabrication method of claim 17, wherein said moving step includes the step of moving said dispensing head and said support member relative to one another in a direction parallel to said plane according to a first determined pattern to form an outer boundary of said mixture on said support member, said outer boundary defining an exterior surface of said object.

24. A freeform fabrication method of claim 23, wherein said outer boundary defines an interior space in said object, and said moving step further includes the step of moving said dispensing head and said support member relative to one another in said direction parallel to said plane according to at least one other predetermined pattern to fill said interior space with said at least one material composition.

25. A freeform fabrication method of claim 24, further comprising the steps of creating a geometry representation of said three-dimensional object on a computer, said geometry representation including a plurality of segments defining said object, and generating programmed signals corresponding to each of said segments in a predetermined sequence, wherein said programmed signals determine said movement of said dispensing head and said support member relative to one another in said first predetermined pattern and said at least one other predetermined pattern.

26. A method as set forth in claim 17, further comprising using dimension sensor means to periodically measure dimensions of the object being built;
using a computer to determine the thickness and outline of individual layers of said dispensed material composition being deposited in accordance with a computer aided design representation of said object; said computer being operated to calculate a first set of logical layers with specific thickness and outline for each layer and then periodically re-calculate another set of logical layers after comparing the dimension data acquired by said sensor means with said computer aided design representation in an adaptive manner.
